(19) United States
(12) Patent Application Publication
(10) Pub. No.: US 2025/0192199 A1
(43) Pub. Date: Jun. 12, 2025

(54) FUEL CELL EXHAUST-GAS SYSTEM

(71) Applicant: Purem GmbH, Neunkirchen (DE)

(72) Inventors: Manuel Notter, Schwaikheim (DE); Enver Kurpejovic, Kirchheim unter Teck (DE)

(21) Appl. No.: 18/972,625

(22) Filed: Dec. 6, 2024

(30) Foreign Application Priority Data
Dec. 7, 2023 (DE) 10 2023 134 234.7

(51) Int. Cl. H01M 8/04119; B01D 45/16; B01D 53/26

(52) U.S. Cl. CPC H01M 8/04164; B01D 45/16; B01D 53/265; B01D 2257/80; B01D 2258/0208; H01M 2250/20

(57) ABSTRACT

A fuel cell exhaust-gas system, in particular for a vehicle, includes a condenser for receiving water-containing fuel cell exhaust gas that has been discharged from a fuel cell unit. A separator, arranged downstream of the condenser, is provided for separating off water that has been condensed out of the water-containing fuel cell exhaust gas fed to the condenser. The separator includes an at least regionally arcuately curved separating channel delimited by a channel wall. The separating channel is surrounded at least in the region of an arc outer side by a separating chamber. A plurality of separating openings, which connect the separating channel to the separating chamber, are provided in the channel wall.

### CROSS-REFERENCE TO RELATED APPLICATIONS

This application claims priority of German patent application no. 10 2023 134 234.7, filed Dec. 7, 2023, the entire content of which is incorporated herein by reference.

### TECHNICAL FIELD

The present disclosure relates to a fuel cell exhaust-gas system which can be used in particular in conjunction with a fuel cell unit which is used in a vehicle to provide electrical energy.

### BACKGROUND

To generate electrical energy, hydrogen (H₂)-containing anode gas and oxygen-containing cathode gas, for example air, are fed to a fuel cell unit. The fuel cell exhaust gas leaving the fuel cell, in particular the cathode exhaust gas, contains a comparatively large proportion of water carried along in the form of water vapor. When the water-containing fuel cell exhaust gas is discharged into the surroundings, depending on the ambient conditions, fog formation and possibly also ice formation on the underlying surface located for example under a vehicle may occur.

### SUMMARY

It is an object of the present disclosure to provide a fuel cell exhaust-gas system with which structurally simple measures can be used to efficiently separate off water contained in the fuel cell exhaust gas.

According to the disclosure, this object is achieved via a fuel cell exhaust-gas system, in particular for a vehicle, including a condenser unit for receiving water-containing fuel cell exhaust gas that has been discharged from a fuel cell unit and a separator unit, arranged downstream of the condenser unit, for separating off water that has been condensed out of the water-containing fuel cell exhaust gas fed to the condenser unit, the separator unit including an at least regionally arcuately curved separating channel delimited by a channel wall, the separating channel being surrounded at least in the region of an arc outer side by a separating chamber, a plurality of separating openings which connect the separating channel to the separating chamber being provided in the channel wall.

The fuel cell exhaust-gas system constructed according to the disclosure uses the centrifugal forces which occur in the arcuately curved separating channel and radially outwardly load the fuel cell exhaust gas and the water contained therein which is condensed out in the region of the condenser unit and is carried along in droplet form, that is, in liquid form. The condensed-out water will precipitate or accumulate in the arcuately curved separating channel on the inner surface of the region of the channel wall on the outside of the arc and enter the separating chamber via the separating openings provided there. Thus, a large part of the water contained in the fuel cell exhaust gas emitted from the fuel cell unit is separated from the gaseous constituents, in particular oxygen and nitrogen, of the fuel cell exhaust gas and can, for example, be fed back into the fuel cell process or collected in liquid form and discharged to the surroundings. The extent of the fog formation in an outlet opening region of the fuel cell exhaust-gas system is thus reduced considerably.

For an efficient separating effect, the separating channel may include an arc segment having an arc angle of at least 90°, preferably approximately 180°.

Since the condensed-out water is forced radially outward in relation to the arc shape of the separating channel by the centrifugal force, it is particularly advantageous if a plurality of the separating openings, preferably all of the separating openings, is or are provided in the region of one half of the channel wall on the outside of the arc. This makes it possible to avoid a weakening of the structural strength by openings which are provided in the radially inner region of the channel wall and are not effective for separation.

To discharge the separated-off water, at least one discharge opening may preferably be provided in a downstream end region of the separating chamber.

In this case, to obtain a compact construction, an end region of the separating chamber, the end region being downstream with respect to a main flow direction of the fuel cell exhaust gas, may be arranged in the region of an arcuately curved portion of the separating channel.

In an alternative embodiment in which a greater length of the separating channel can be used, provision may be made for a substantially rectilinearly extending portion of the separating channel to adjoin a downstream end of an arcuately curved portion of the separating channel, and for an end region of the separating chamber, the end region being downstream with respect to a main flow direction of the fuel cell exhaust gas, to be arranged in the region of the substantially rectilinearly extending portion of the separating channel.

In order to further assist the separating off of water from the fuel cell exhaust gas, it is proposed that at least one separating stop extending into the separating channel is provided at least in a region of the channel wall on the outside of the arc. Water that is carried along in the fuel cell exhaust gas and is present in droplet form can precipitate on such a separating stop which protrudes radially inwardly with respect to the arcuately curved form of the separating channel, and can then be discharged, under the effect of centrifugal force or/and the effect of gravity, radially outward into the region of the channel wall and the separating openings provided therein.

For an efficient separating effect, it is proposed that at least one separating stop is arranged downstream of the at least one discharge opening.

To further assist the discharging of condensed-out water that is to be loaded in the direction of the channel wall, at least one separating opening may be formed as a slot extending in a peripheral direction around a channel central axis of the separating channel.

For efficient separation, it is also advantageous if at least one separating opening formed as a slot is arranged downstream of the at least one discharge opening.

Particularly efficient cooperation between separating stop and separating opening of slot-like form can be achieved if at least one separating stop is arranged downstream of at least one separating opening formed as a slot.

The disclosure also relates to a fuel cell system, preferably in a vehicle, including at least one fuel cell unit and a fuel cell exhaust-gas system which is constructed according to the disclosure and receives fuel cell exhaust gas from the at least one fuel cell unit.

In order to assist the discharging of water separated off from the fuel cell exhaust gas, it is advantageous if the separating channel is downwardly curved in a height direction, that is, a vertical direction, in such a way that an upstream end region of the separating channel is positioned higher in the height direction than a downstream end region of the separating channel.

### BRIEF DESCRIPTION OF DRAWINGS

The invention will now be described with reference to the drawings wherein:

FIG. 1 shows a side view of a fuel cell exhaust-gas system;

FIG. 2 shows the fuel cell exhaust-gas system in FIG. 1 partially in longitudinal section;

FIG. 3 shows a separator unit of the fuel cell exhaust-gas system in FIG. 1;

FIG. 4 shows a perspective view of the separator unit in FIG. 3;

FIG. 5 shows a region of the channel wall of the separator unit in FIG. 3;

FIG. 6 shows a side view of an alternative configuration of the separator unit;

FIG. 7 shows a view, corresponding to FIG. 2, of an alternative configuration of the separator unit;

FIG. 8 shows a diagrammatic representation of a sectional view of the separator unit in FIG. 7, sectioned along line VIII-VIII in FIG. 7;

FIG. 9 shows a side view of an alternative configuration of the separator unit; and,

FIG. 10 shows a diagrammatic representation of a fuel cell system.

### DETAILED DESCRIPTION

In FIG. 10, a fuel cell system which can be used for example in a vehicle in order to provide electrical energy for driving operation is denoted generally by 10. The fuel cell system 10 includes a fuel cell unit 12, formed for example as a fuel cell stack, having an anode region 14 and a cathode region 16. Hydrogen or hydrogen-containing gas is fed as anode gas A to the anode region 14. Oxygen or oxygen-containing gas, for example air, is fed as cathode gas K to the cathode region 16. A hydrogen-depleted anode exhaust gas is produced in the anode region 14, whereas a cathode exhaust gas that is enriched with water or water vapor is produced in the cathode region 16. These two gas flows may, for example, be merged and introduced as fuel cell exhaust gas B into a fuel cell exhaust-gas system 18. The fuel cell exhaust-gas system 18 discharges the fuel cell exhaust gas B to the surroundings.

In order to avoid fog formation when fuel cell exhaust gas B exits the fuel cell exhaust-gas system 18 to the surroundings, in particular in the presence of low ambient temperatures, measures are provided in the fuel cell exhaust-gas system 18 to remove water that leads to fog formation from the fuel cell exhaust gas B.

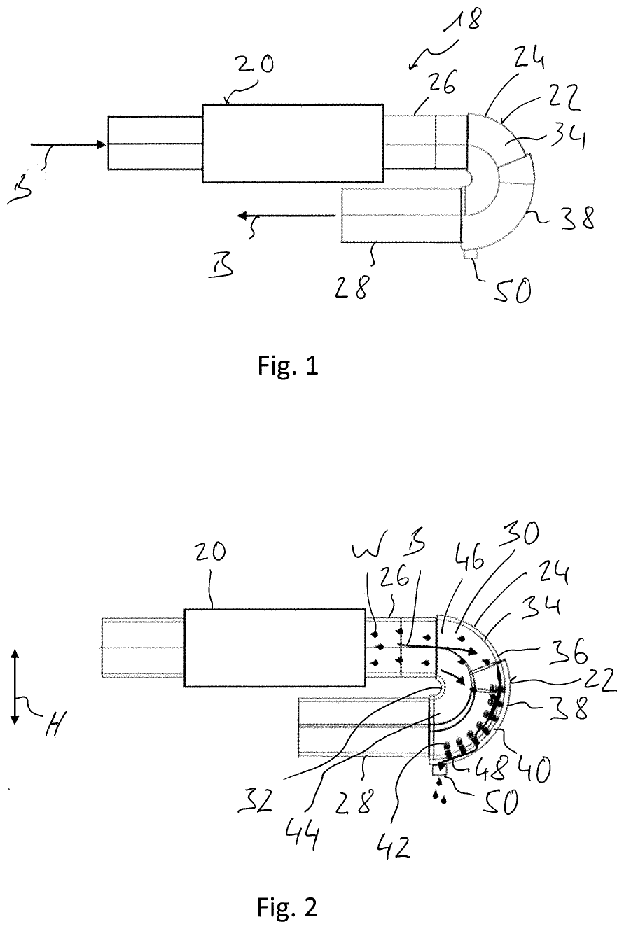

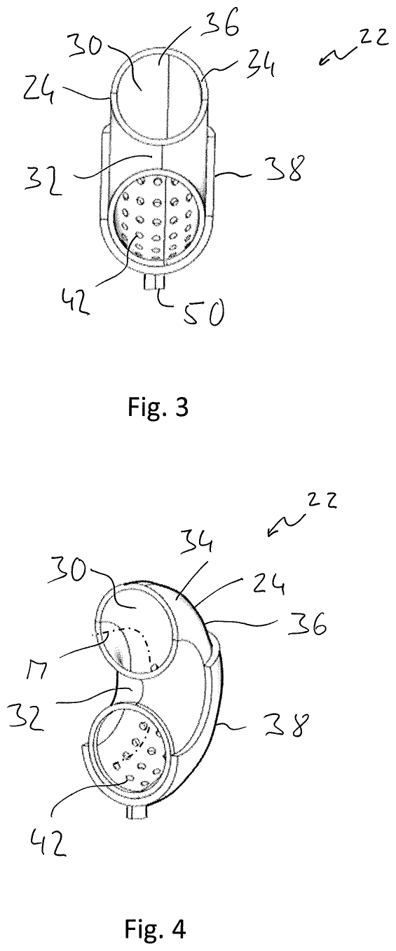

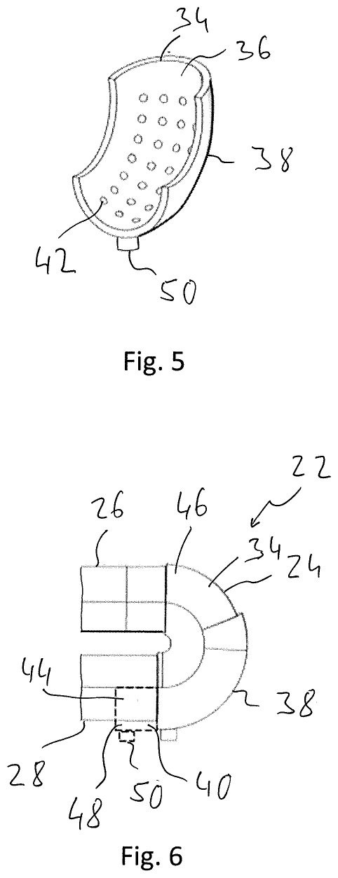

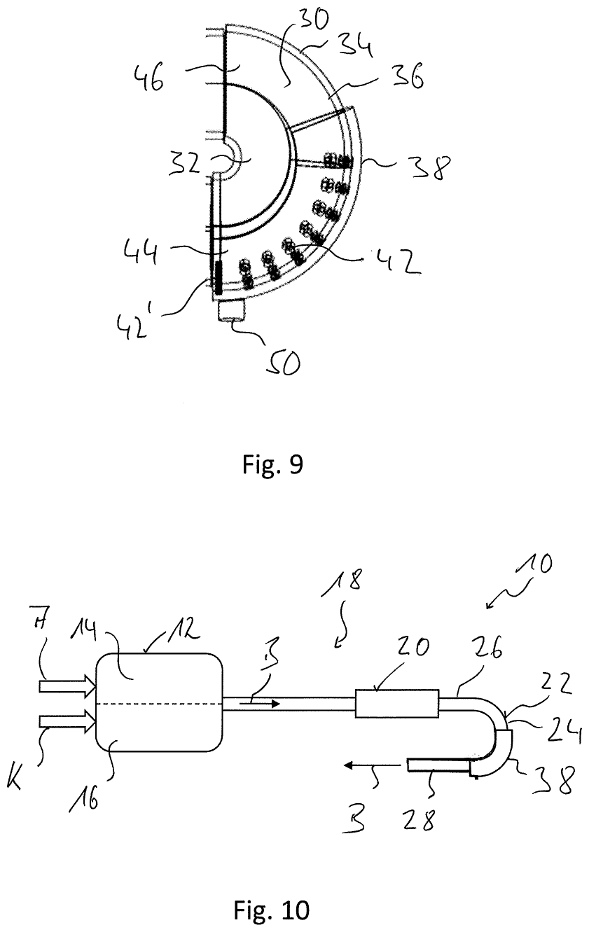

The fuel cell exhaust-gas system 18 includes one or more condenser units 20 through which the fuel cell exhaust gas B can flow. In the condenser unit 20, for example thermal interaction of the fuel cell exhaust gas B with the comparatively cold ambient air triggers a condensation process, which has the effect that a significant part of the water contained as vapor, that is, as gas, in the fuel cell exhaust gas B is condensed out and carried along in droplet form in the fuel cell exhaust gas B leaving the condenser unit 20. In a separator unit 22 which is downstream of the condenser unit 20 and will be described in detail below with reference to FIGS. 1 to 9, the or a majority of the condensed-out water is separated from the remaining gaseous constituents of the fuel cell exhaust gas B, that is, essentially oxygen and nitrogen, collected and for example fed back into the fuel cell process or discharged in liquid form to the surroundings.

The separator unit 22 illustrated in a first embodiment in FIGS. 1 to 5 includes an arcuate pipe portion 24 which for example adjoins a substantially rectilinearly extending portion 26 that leads away from the condenser unit 20. The arcuate pipe portion 24 forms, for example, an arc segment having an arc angle of approximately 180°, meaning that the fuel cell exhaust gas B flowing through the arcuate pipe portion 24 experiences a flow deflection by approximately 180°. The arcuate pipe portion 24 may, for example, in turn be followed by a substantially rectilinearly extending pipe portion 28 in which the fuel cell exhaust gas B flows substantially in the direction opposite to the flow direction in the pipe portion 26, or upstream of the condenser unit 20.

In the arcuate pipe portion 24, a separating channel 30 through which the fuel cell exhaust gas B flows in a main flow direction of the fuel cell exhaust gas approximately in the direction of a channel central axis M is formed, in which, owing to the deflection of the fuel cell exhaust gas B and the resultant centrifugal forces, both the gaseous constituents of the fuel cell exhaust gas B and the water droplets W contained therein are radially outwardly loaded. This has the result that, in the region 32 of the arcuate pipe portion 24 on the inside of the arc, or of a channel wall 34 bordering the separating channel 30, flow separation radially outwardly occurs, assisting the radially outward loading of the water droplets W carried along in the fuel cell exhaust gas B. These water droplets are therefore accumulated in an enhanced manner in a region 36 of the channel wall 34 on the outside of the arc and also move in the flow direction of the fuel cell exhaust gas B along the region 36 of the channel wall 34 on the outside of the arc.

The channel wall 34 of the arcuate pipe portion 24 is regionally surrounded by a separating chamber wall 38. This relates in particular to the region on the outside of the arc or to the half of the channel wall 34 on the outside of the arc and approximately to the downstream half of the arcuate pipe portion 24. In the region covered by the separating chamber wall 38, the channel wall 34 together with the separating chamber wall 38 delimits a separating chamber that is denoted generally by 40. In the region in which the separating channel 30 is covered in its region on the outside of the arc or downstream region by the separating chamber 40, a plurality of separating openings 42 is provided in the channel wall 34. The separating openings 42 are positioned substantially in the region of the half of the channel wall 34 on the outside of the arc, that is, the region in which, owing to the effect of centrifugal force and owing to the flow direction of the fuel cell exhaust gas B in the separating channel 30, the radially outwardly loaded water droplets W accumulate.

By way of the separating openings 42, the water droplets W accumulating on the inner side of the channel wall 34 or the water separated off from the fuel cell exhaust gas B in the condenser unit 20 pass/passes into the separating chamber 40. Since the arcuate pipe portion 24 is positioned in such a way that it leads radially downward proceeding from the substantially rectilinearly extending channel portion 26, with the result that the upstream end region 44 of the separating channel 30 lies substantially under an upstream end region 46 of the separating channel 30 in a height direction H or in the vertical direction, which has the effect that the downstream end region 48 of the separating chamber 40 is positioned at the bottom in a height direction, the water that has passed through the separating openings 42 into the separating chamber 40 flows downward into the region of a discharge opening 50 under the effect of gravity.

The discharge opening 50 provided in the downstream end region 48 or/and in a lowermost region of the separating chamber 40 in the height direction H may, in principle, be open, such that the liquid water passing into the region thereof can exit the separating chamber 40 without the risk of fog forming and can drop onto an underlying surface located under the fuel cell exhaust-gas system 18. As an alternative, the discharge opening 50 could be shut off by a valve unit, such that, at defined points in time, water can be discharged from the separating chamber 40 and can for example also be fed back via corresponding lines to the fuel cell unit 12.

In a modified configuration illustrated in FIG. 6, the separating channel 30 extends, as indicated by dashed lines, beyond the 180° arc segment provided by the arcuate pipe portion 24 for example into the region of the rectilinearly extending pipe portion 28 or into a correspondingly extended portion of the arcuate pipe portion 24. The separating chamber 40 also extends beyond the arc segment of the arcuate pipe portion 24 into this rectilinearly extending region, such that a greater volume or a longer flow path can be provided both for the separating channel 30 and for the separating chamber 40 in order to thereby be able to achieve further-improved separating behavior. The region in which the separating openings 42 are provided may also extend into this rectilinearly extending region, providing the downstream end region 44 of the separating channel 30 or of the pipe portion 24, of the separating channel 30 or of the channel wall 34 bordering the latter.

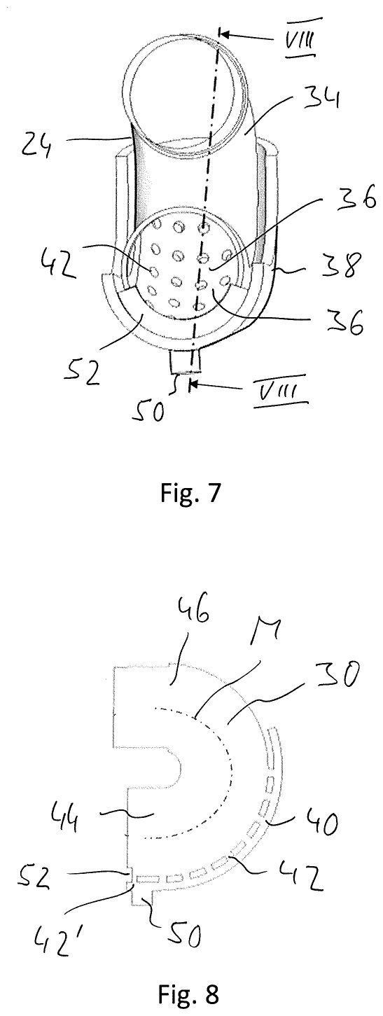

FIGS. 7 to 9 show a further configuration of the separator unit 22, in which special structural measures assist the separating off of water or water droplets from the fuel cell exhaust gas B.

FIGS. 7 and 8 show that a separating stop 52 extending into the separating channel 30 is provided downstream of the discharge opening 50. The separating stop 52 extends radially inward with respect to the channel central axis M from the region 36 of the channel wall 34 on the outside of the arc and thus forms a flow obstacle for water droplets W that are still being carried along with the fuel cell exhaust gas B in the region of the separating channel 30 on the outside of the arc. These water droplets strike against the separating stop 52. Since the separating stop 52 is positioned in the downstream end region 44 of the separating channel 30, the water accumulating on the separating stop 52 moves radially outward or downward due to gravity. Positioned directly upstream of the separating stop 52 is a separating opening 42 extending in the form of a slot in a peripheral direction around the channel central axis M. Preferably, the extent length of the separating opening 42′ formed as a slot is approximately as long as the extent length of the separating stop 52 around the channel central axis M. The water accumulating on the separating stop 52 can thus flow unimpeded downward in the height direction through the separating opening 42′ formed as a slot into the separating chamber 40 and to the discharge opening 50.

In the case of the fuel cell exhaust-gas system constructed according to the disclosure, the regionally double-walled configuration forms a separating chamber which covers or surrounds the separating channel, through which fuel cell exhaust gas flows, in a region on the outside of the arc and in which, owing to the radially outward loading of the water droplets, that is, in the direction of that region of the channel wall bordering the separating channel which is on the outside of the arc, the water that has been condensed out in a condenser unit and separated from the gaseous constituents of the fuel cell exhaust gas is collected. Further measures that are necessary for the separation of the water and may result in flow obstructions are therefore not required. In the fuel cell exhaust-gas system constructed according to the disclosure, it is only the forces acting on the condensed-out water when it is flowing through the separator unit, that is, the centrifugal force and the force of gravity, that are used to efficiently separate condensed-out water from the gaseous constituents of the fuel cell exhaust gas.

It is understood that the foregoing description is that of the preferred embodiments of the invention and that various changes and modifications may be made thereto without departing from the spirit and scope of the invention as defined in the appended claims.

1. A fuel cell exhaust-gas system receiving water-containing fuel cell exhaust gas, the fuel cell exhaust-gas system comprising:
a condenser for receiving the water-containing fuel cell exhaust gas discharged from said fuel cell unit;
a separator arranged downstream of said condenser for separating off water that has been condensed out of the water-containing fuel cell exhaust gas fed to said condenser;
said separator including a channel wall delimiting a separating channel of which at least a segment is an arcuately curved portion defining an arc outer side;
a separating chamber surrounding said separating chamber at least in the region of said arc outer side; and,
said channel wall having a plurality of separating openings formed therein connecting said separating channel to said separating chamber.

2. The fuel cell exhaust-gas system of claim 1, wherein said separating channel includes an arc segment having an arc angle of one of the following:
i) at least 90°; and,
ii) at least 180°.

3. The fuel cell exhaust-gas system of claim 1, wherein one of the following applies:
i) a plurality of said plurality of said separating openings is provided in the region of one half of said channel wall on the outside of the arc; and,
ii) all of said separating openings are provided in the region of one half of said channel wall on the outside of the arc.

4. The fuel cell exhaust-gas system of 1, wherein at least one of the following applies: I) said separating chamber is provided with at least one discharge opening; and, ii) said separating chamber is provided with at least one discharge opening in a downstream end region of said separating chamber.

5. The fuel cell exhaust-gas system of claim 4, wherein said fuel cell exhaust gas has a main flow direction and said downstream end region of said separating chamber is downstream with respect to said main flow direction of said fuel cell exhaust gas and is arranged in the region of said arcuately curved portion of said separating channel.

6. The fuel cell exhaust-gas system of claim 4, wherein:
said arcuately curved portion has a downstream end;
a rectilinearly extending portion of said separating channel adjoins said downstream end of said arcuately curved portion of said separating channel;
said separating chamber has an end region downstream with respect to a main flow direction of the fuel cell exhaust gas; and,
said end region of said separating chamber is arranged in the region of said rectilinearly extending portion of said separating channel.

7. The fuel cell exhaust-gas system of claim 1, further comprising at least one separating stop extending into said separating channel and being provided at least in a region of said channel wall on the outside of the arc.

8. The fuel cell exhaust-gas system of claim 4, wherein at least one separating stop is arranged downstream of said at least one discharge opening.

9. The fuel cell exhaust-gas system of claim 1, wherein at least one of said separating openings is formed as a slot extending in a peripheral direction around a channel central axis of said separating channel.

10. The fuel cell exhaust-gas system of claim 9, wherein at least one discharge opening is provided in a downstream end region of said separating channel; and, said at least one separating opening formed as a slot is arranged downstream of said at least one discharge opening.

11. The fuel cell exhaust-gas system of claim 10, wherein at least one separating stop is arranged downstream of said at least one separating opening formed as a slot.

12. The fuel cell exhaust-gas system of claim 1, wherein said fuel cell exhaust-gas system is for a vehicle.

13. A fuel cell system comprising:
at least one fuel cell unit discharging water-containing fuel cell exhaust gas;
a fuel cell exhaust-gas system including:
a condenser for receiving the water-containing fuel cell exhaust gas discharged from said fuel cell unit;
a separator arranged downstream of said condenser for separating off water that has been condensed out of the water-containing fuel cell exhaust gas fed to said condenser;
said separator including a channel wall delimiting a separating channel of which at least a segment is an arcuately curved portion defining an arc outer side;
a separating chamber surrounding said separating chamber at least in the region of said arc outer side; and,
said channel wall having a plurality of separating openings formed therein connecting said separating channel to said separating chamber.

14. The fuel cell system of claim 13, wherein said fuel cell system is for a vehicle.

15. The fuel cell system of claim 13, wherein said separating channel is downwardly curved in a height direction in such a way that an upstream end region of said separating channel is positioned higher in the height direction than a downstream end region of the separating channel.
